(19) United States
(12) Patent Application Publication
(10) Pub. No.: US 2025/0091429 A1
(43) Pub. Date: Mar. 20, 2025

(54) ELECTRIC DRIVE DEVICE

(71) Applicant: DENSO CORPORATION, Kariya-city (JP)

(72) Inventors: YOSHINORI AKITSU, Kariya-city (JP); KIYOSHI FUJII, Kariya-city (JP)

(21) Appl. No.: 18/959,138

(22) Filed: Nov. 25, 2024

Related U.S. Application Data
(63) Continuation of application No. PCT/JP2023/017135, filed on May 2, 2023.

(30) Foreign Application Priority Data
May 27, 2022 (JP) 2022-086724

(51) Int. Cl. B60K 7/00; B60K 17/04; B60L 15/20; B62D 5/04

(52) U.S. Cl. CPC B60K 7/0007; B60K 17/043; B60L 15/20; B62D 5/0418; B60L 2200/40

(57) ABSTRACT

An electric drive device is applied to a vehicle having drive wheels and rotates the drive wheels about a rotation central axis extending in a horizontal direction to drive the vehicle. The electric drive device includes a drive unit provided on an underside of a base portion of the vehicle and having a motor and a transmission mechanism connected to the drive wheels, and a steering mechanism provided on the underside of the base portion and having a steering center shaft extending in a vertical direction. The steering mechanism supports the drive unit relative to the base portion so that the drive unit can rotate about a steering center shaft while maintaining a rotational central axis of the drive wheels in a horizontal state. A position of the steering center shaft is offset in the horizontal direction from a contact area of the drive wheels with a driving road surface.

### CROSS REFERENCE TO RELATED APPLICATIONS

This application is a continuation application of International Patent Application No. PCT/JP2023/017135 filed on May 2, 2023, which designated the U.S. and based on and claims the benefits of priority of Japanese Patent Application No. 2022-086724 filed on May 27, 2022. The entire disclosure of all of the above applications is incorporated herein by reference.

### TECHNICAL FIELD

The present disclosure relates to an electric drive device.

### BACKGROUND

As an example of this type of electric drive device, there is known the electric drive device that is applied to an automated guided vehicle equipped with drive wheels, and causes the automated guided vehicle to drive by rotating the drive wheels around a central axis of rotation that extends horizontally.

An object of the present disclosure is to provide an electric drive device capable for simplifying the configuration.

The present disclosure relates to an electric drive device that is applied to a vehicle having drive wheels and that rotates the drive wheels about a rotation central axis extending in a horizontal direction to drive the vehicle. The electric drive device includes a drive unit provided below a base portion of the vehicle, the drive unit having a motor and a transmission mechanism connected to the drive wheels and transmitting a rotational power of the motor to the drive wheels, and a steering mechanism having a steering center shaft extending in the vertical direction and provided below the base portion.

The steering mechanism supports the drive unit rotatably about the steering center shaft relative to the base portion while maintaining a rotation central axis of the drive wheels in a horizontal state, and the steering mechanism is configured such that a position of the steering center shaft is offset in the horizontal direction from a contact area of the drive wheels with a driving road surface.

The steering mechanism of the present disclosure is configured such that the position of the steering center shaft extending vertically in the horizontal direction is offset from the contact points of the drive wheels with the road surface on which the vehicle is driving.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an overall configuration of an automated guided vehicle according to a first embodiment;

FIG. 2 is a side view of an automated guided vehicle;

FIG. 3 is a perspective view showing an overall configuration of an electric drive device;

FIG. 4 is a diagram showing an internal structure of a motor and a deceleration device;

FIG. 5 is a cross-sectional view taken along a line V-V of FIG. 4, showing a motor portion;

FIG. 6 is a diagram showing an electrical configuration of an automated guided vehicle;

FIG. 7 is a plan view of the electric drive device in a state in which steering by the steering mechanism is locked;

FIG. 8 is a diagram showing a configuration in a vicinity of a case in a state in which steering by a steering mechanism is locked;

FIG. 9 is a plan view of the electric drive device in a state where steering by a steering mechanism is not locked;

FIG. 10 is a diagram showing a configuration in a vicinity of the case when steering by the steering mechanism is not locked;

FIG. 11 is a diagram showing an example of a driving mode of an automated guided vehicle;

FIG. 12 is a diagram showing an example of a driving mode of an automated guided vehicle;

FIG. 13 is a flowchart showing a processing procedure for driving control of an automated guided vehicle;

FIG. 14 is a plan view of the electric drive device during turning by the steering mechanism;

FIG. 15 is a plan view of the electric drive device when turning is completed;

FIG. 16 is a plan view of the electric drive device in a locked state after completing a turning;

FIG. 17 is a flowchart showing a processing procedure for driving control of an automated guided vehicle according to a second embodiment;

FIG. 18 is a plan view of an electric drive device according to a third embodiment; and

FIG. 19 is a side view of the electric drive device.

### DETAILED DESCRIPTION

As an example of this type of electric drive device, there is known the electric drive device that is applied to an automated guided vehicle equipped with drive wheels, and causes the automated guided vehicle to drive by rotating the drive wheels around a central axis of rotation that extends horizontally. This electric drive device includes a drive mechanism that rotates the drive wheels, and a steering mechanism that changes the direction of the drive wheels around a steering shaft that extends in a vertical direction. The drive mechanism and steering mechanism are provided under a carriage body of the automated guided vehicle.

The steering mechanism includes a steering motor for changing the direction of the drive wheels. There is a concern that the steering mechanism configuration may become complicated.

An object of the present disclosure is to provide an electric drive device capable for simplifying the configuration.

The present disclosure relates to an electric drive device that is applied to a vehicle having drive wheels and that rotates the drive wheels about a rotation central axis extending in a horizontal direction to drive the vehicle. The electric drive device includes a drive unit provided below a base portion of the vehicle, the drive unit having a motor and a transmission mechanism connected to the drive wheels and transmitting a rotational power of the motor to the drive wheels, and a steering mechanism having a steering center shaft extending in the vertical direction and provided below the base portion.

The steering mechanism supports the drive unit rotatably about the steering center shaft relative to the base portion while maintaining a rotation central axis of the drive wheels in a horizontal state, and the steering mechanism is configured such that a position of the steering center shaft is offset in the horizontal direction from a contact area of the drive wheels with a driving road surface.

The steering mechanism of the present disclosure is configured such that the position of the steering center shaft extending vertically in the horizontal direction is offset from the contact points of the drive wheels with the road surface on which the vehicle is driving. Therefore, when rotational power is transmitted from the motor through the transmission mechanism to the drive wheels with the drive wheels in contact with the road surface, a moment is generated in the steering mechanism to rotate the drive unit around the steering center shaft. In this case, the drive unit rotates around the steering center shaft relative to the base portion of the vehicle while maintaining the rotation central axis of the drive wheels in a horizontal state. In other words, the drive wheels can be steered. In this manner, in the present disclosure, the drive wheels can be steered by the rotational power of the motor for driving the vehicle. Therefore, there is no need for a motor for steering the drive wheels in addition to a motor for driving the vehicle. This makes it possible to simplify the configuration of the electric drive device that includes the drive unit and the steering mechanism.

### First Embodiment

Hereinafter, a first embodiment in which an electric drive device according to the present disclosure is applied to an automated guided vehicle as a vehicle will be described with reference to the drawings. The automated guided vehicle of the present embodiment is an AGV (Automatic Guided Vehicle) used to transport parts in a production line in a factory or in a work area such as a warehouse. The automated guided vehicle is computer-controlled and automatically drives along a predetermined route in the work area.

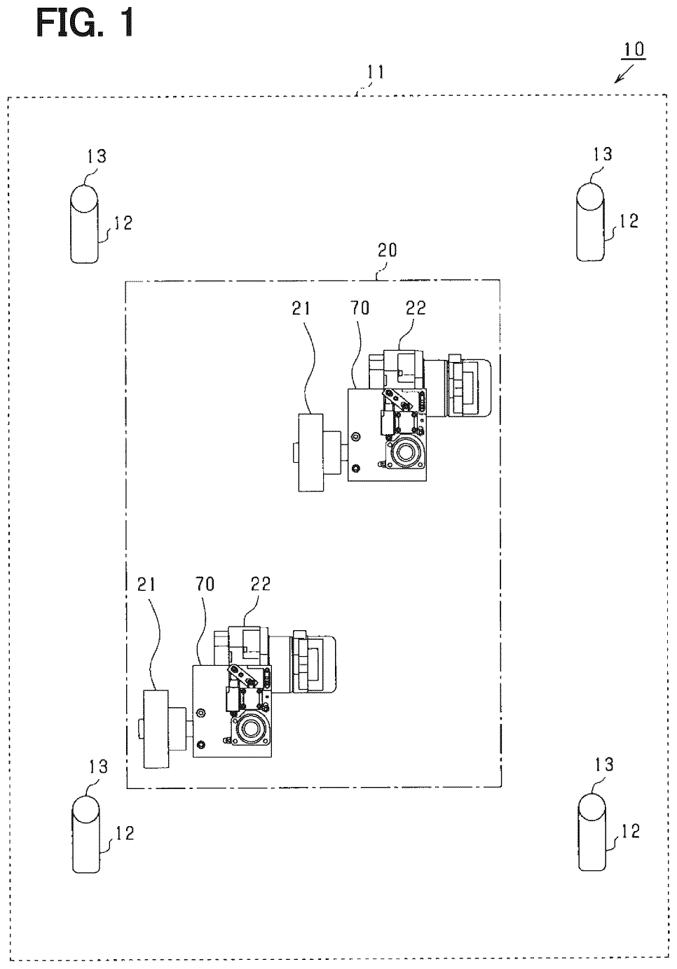

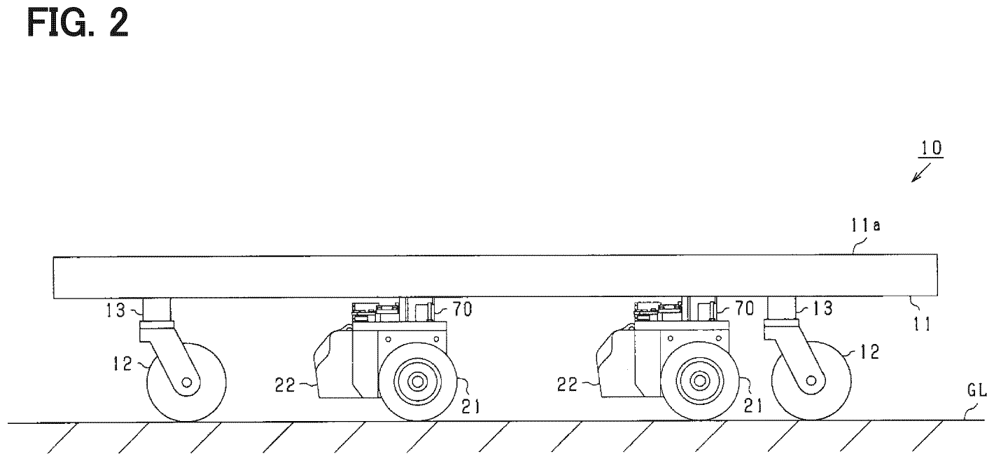

As shown in FIGS. 1 and 2, the automated guided vehicle 10 includes a base portion 11 and driven wheels 12. The base portion 11 is in the form of a plate, and has a rectangular shape (specifically, a rectangular shape) in a plan view. An upper surface of the base portion 11 serves as a mounting surface 11a on which an object to be transported is placed. The placement surface is approximately parallel to the road surface GL on which the automated guided vehicle 10 drives. In FIG. 1, an outer periphery of the base portion 11 is depicted by a dashed line, and the configuration below the mounting surface 11a of the base portion 11 is depicted by a solid line.

The driven wheels 12 are provided at the four corners on the lower surface of the base portion 11. That is, in the present embodiment, two rows of driven wheels 12 are provided in a vehicle width direction of the automated guided vehicle 10, and two rows of driven wheels 12 are provided in a vehicle length direction. Each driven wheel 12 supports the base portion 11 from below.

The driven wheel 12 is supported by a driven wheel mounting portion 13. The driven wheel 12 is attached to a lower end of the driven wheel mounting portion 13 so as to be rotatable around a central axis of rotation extending horizontally. An upper end of the driven wheel mounting portion 13 is attached to the base portion 11 so as to be rotatable around a central axis of rotation that extends in the vertical direction. When the automated guided vehicle 10 drives straight ahead or backward, the driven wheels 12 rotate with the central axis of rotation of the driven wheels 12 extending in the vehicle width direction. On the other hand, when the automated guided vehicle 10 drives in the vehicle width direction, the driven wheels 12 rotate with the central axis of rotation of the driven wheels 12 extending in the vehicle length direction.

The automated guided vehicle 10 is equipped with an electric drive device 20 attached to the lower surface of the base portion 11. The electric drive device 20 includes drive wheels 21, a drive unit 22 that drives and rotates the drive wheels 21, and a steering mechanism 70 that steers the drive wheels 21. The electric drive device 20 of the present embodiment has multiple (two) drive wheels 21, drive units 22 individually provided corresponding to each drive wheel 21, and the steering mechanisms 70 individually provided corresponding to each drive wheel 21. In the present embodiment, each drive unit 22 has the same configuration, and each steering mechanism 70 has the same configuration. When the base portion 11 is viewed from above, each drive wheel 21 is provided on a diagonal line of a corner of the base portion 11. In the present embodiment, a diameter of the drive wheel 21 is the same as a diameter of the driven wheel 12.

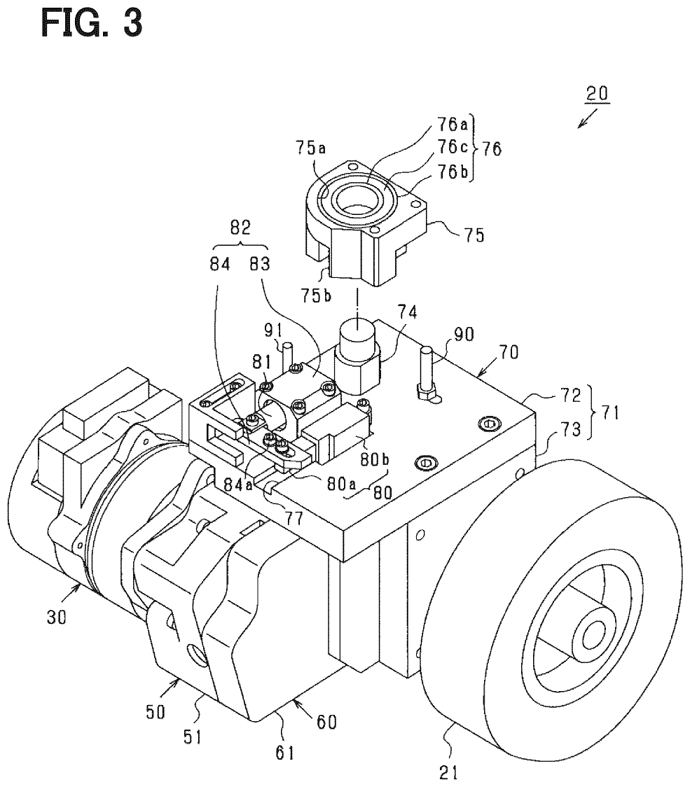

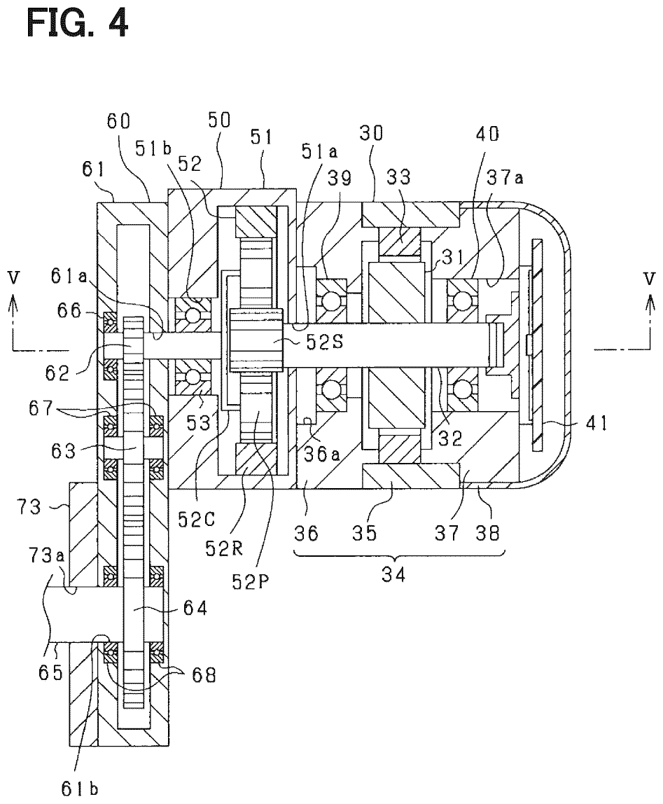

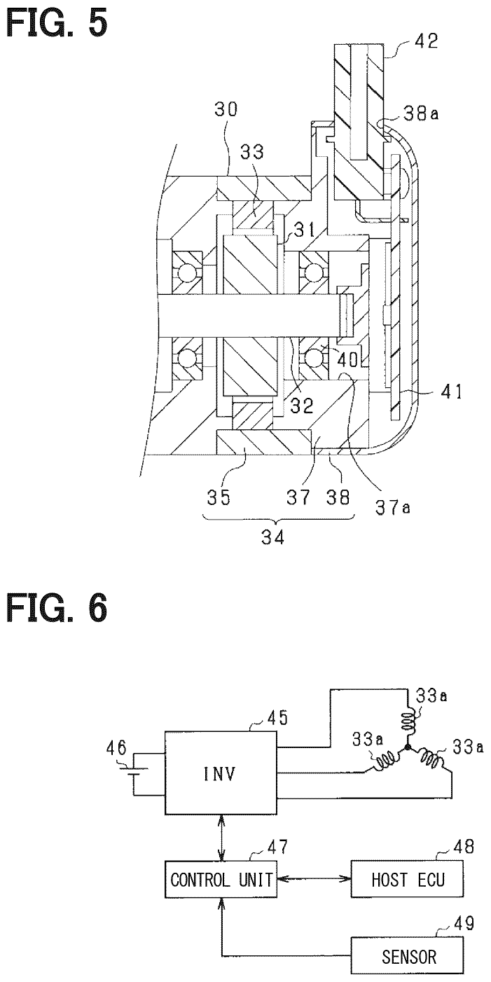

First, the drive unit 22 will be described with reference to FIGS. 3 to 5. FIG. 5 is a cross-sectional view showing the motor 30 portion in the cross-sectional view taken along a line V-V in FIG. 4. For the sake of convenience, some of the components shown in FIGS. 4 and 5 are simplified with respect to the components shown in FIG. 3.

The drive unit 22 is provided below the base portion 11. The drive unit 22 includes a motor 30, a first deceleration device 50 and a second deceleration device 60. The rotational power of a rotor 31 constituting the motor 30 is transmitted to the drive wheels 21 via each of the deceleration devices 50 and 60. In the present embodiment, each of the deceleration devices 50, 60 corresponds to a “transmission mechanism.”

The motor 30 includes a rotor 31 having field poles (e.g., permanent magnets), a shaft 32 fixed to the rotor 31, and a stator 33 disposed radially outwardly facing the rotor 31. The central axis of rotation of the shaft 32 extends horizontally. The stator 33 includes a stator core (not shown) and a stator winding 33a (see FIG. 6) wound around the stator core.

The motor 30 includes a motor housing 34. The motor housing 34 has a tubular portion 35, a first connecting portion 36, a second connecting portion 37, and a cover portion 38. The tubular portion 35 has a long tubular shape extending in a direction in which the shaft 32 extends, and more specifically, has a cylindrical shape. The first connecting portion 36 is provided on a first end side of both ends in the longitudinal direction of the tubular portion 35, and a second connecting portion 37 is provided on a second end side thereof. The rotor 31 and the stator 33 are housed in a cylindrical space surrounded by the tubular portion 35, the first connecting portion 36, and the second connecting portion 37. The stator 33 is provided on an inner circumferential surface of the tubular portion 35. The cross section of the motor housing 34 is not limited to being cylindrical, but may be, for example, rectangular.

The first connecting portion 36 has a first opening 36a formed therein. A first bearing 39 is provided in the first opening 36a. Further, a second opening 37a is formed in the second connecting portion 37, and a second bearing 40 is provided in the second opening 37a. In the present embodiment, each of the bearings 39, 40 is a rolling bearing having an inner ring, an outer ring, and rolling elements provided between the inner ring and the outer ring. A first end side of the shaft 32 is rotatably supported by the first bearing 39, and a second end side of the shaft 32 is rotatably supported by the second bearing 40.

A cover portion 38 is provided on the second connecting portion 37 on the opposite side to the tubular portion 35 in the longitudinal direction of the motor housing 34. A control board 41 is disposed in a space surrounded by the second connecting portion 37 and the cover portion 38. In the present embodiment, the control board 41 is disposed so that a plate surface of the control board 41 is perpendicular to the direction in which the shaft 32 extends. The control board 41 is provided with an inverter 45 (see FIG. 6), which will be described later. As shown in FIG. 5, the cover portion 38 is formed with a connector opening 38a. A connector 42 electrically connected to the control board 41 is inserted into the connector opening 38a. The connector 42 includes a power connector and a communication connector.

Next, the first deceleration device 50 will be described. The first deceleration device 50 amplifies and outputs the input torque from the shaft 32 of the motor 30. The first deceleration device 50 includes a first housing 51 connected to the first connection portion 36. The first housing 51 accommodates a planetary gear mechanism 52. The planetary gear mechanism 52 includes a sun gear 52S fixed to the shaft 32, a plurality of planetary gears 52P meshing with the sun gear 52S, a ring gear 52R meshing with the planetary gears 52P, and a planetary carrier 52C rotatably supporting the planetary gears 52P. A central axis of rotation of the sun gear 52S and a central axis of rotation of the shaft of the planetary carrier 52C are the same.

The sun gear 52S is an external gear, and is fixed to the shaft 32 inserted through the first opening 51a of the first housing 51 and rotates integrally with the shaft 32. The ring gear 52R is an annular internal gear, and is fixed to the inner circumferential surface of the first housing 51. The planetary gear 52P is an external gear, and is rotatably supported by a shaft of the planetary carrier 52C via a rolling bearing.

A second opening 51b is formed in the first housing 51, and a bearing 53 (rolling bearing) is provided in the second opening 51b. The bearing 53 rotatably supports the shaft of the planetary carrier 52C.

The reduction mechanism housed in the first housing 51 may be, for example, a cycloid gear mechanism.

Next, the second deceleration device 60 will be described. The second deceleration device 60 amplifies and outputs the input torque from the shaft of the planetary carrier 52C. In the present embodiment, in order to suppress an increase in the size of the drive unit 22 in the vehicle width direction, the second deceleration device 60 is configured to be long in the vehicle length direction. The second deceleration device 60 includes a second housing 61 connected to the first housing 51.

The second housing 61 accommodates a plurality of spur gears. More specifically, a first gear 62, a second gear 63, and a third gear 64 are accommodated in the second housing 61 and are aligned in the vehicle length direction. The central axis of rotation of each of the gears 62 to 64 extends in the same direction as the shaft 32.

The second housing 61 is formed with a first opening 61a, and the shaft of the planetary carrier 52C is inserted through the first opening 61a. An end of the shaft of the planetary carrier 52C is rotatably supported by a first bearing 66 (a rolling bearing) provided in the second housing 61. In addition, a first gear 62 is provided on this shaft. The second gear 63 meshing with the first gear 62 is rotatably supported by a second bearing 67 (rolling bearing) provided in the second housing 61, and the third gear 64 meshing with the second gear 63 is rotatably supported by a third bearing 68 (rolling bearing) provided in the second housing 61.

The diameter of the second gear 63 is larger than the diameter of the first gear 62, and the diameter of the third gear 64 is larger than the diameter of the second gear 63. In other words, the diameter of each of the gears 62 to 64 housed in the second housing 61 increases from the first opening 61a side toward the second opening 61b side in the longitudinal direction of the second housing 61. As a result, the rotational speed of the third gear 64 relative to the first gear 62 is reduced, and the input torque of the first gear 62 is amplified and output from the third gear 64.

A drive shaft 65 extending horizontally is fixed to the third gear 64. A first end of the drive shaft 65 is rotatably supported by a third bearing 68 provided in the second housing 61. The drive shaft 65 is inserted through the second opening 61b of the second housing 61. The drive wheel 21 is connected to a second end of the drive shaft 65.

Next, the electrical configuration of the automated guided vehicle 10 will be described with reference to FIG. 6.

The automated guided vehicle 10 is equipped with a power storage unit 46. The power storage unit 46 is, for example, a secondary battery such as a lithium ion battery.

An inverter 45 and a control unit 47 is provided on the control board 41 of each of drive units 22. The inverter 45 has upper and lower arm semiconductor switches for three phases. The inverter 45 converts DC power supplied from the power storage unit 46 of the automated guided vehicle 10 into AC power and supplies it to the stator winding 33a, by controlling the switching of the semiconductor switches of the upper and lower arms.

Each drive unit 22 is equipped with a sensor 49. The sensor 49 includes a current sensor and a rotation angle sensor. The current sensor detects the current (phase current) flowing through the stator winding 33a. The rotation angle sensor detects a rotation angle position (electrical angle) of the rotor 31. The detection value of the sensor 49 is input to the control unit 47. In the present embodiment, the current sensor and the rotation angle sensor are housed in the motor housing 34.

The control unit 47 is mainly constituted by a microcomputer. The control unit 47 performs switching control of the inverter 45 so as to control the control amount of the motor 30 to a command value based on each detected value. The control amount is, for example, torque.

The control unit 47 of each drive unit 22 communicates with a host ECU 48 provided in the automated guided vehicle 10 via a communication connector that constitutes the connector 42. The host ECU 48 is mainly composed of a microcomputer. The host ECU 48 transmits command values to the control unit 47 of each of the drive units 22 via a communication connector so as to realize desired control, such as drive control of the automated guided vehicle 10. When the host ECU 48 determines that the automated guided vehicle 10 has been instructed to drive straight ahead, it sends a command value to the control unit 47 of each of the drive units 22 so that the drive wheels 21 of each drive unit 22 rotate in the same direction and so that the rotational speeds of each drive wheel 21 are the same.

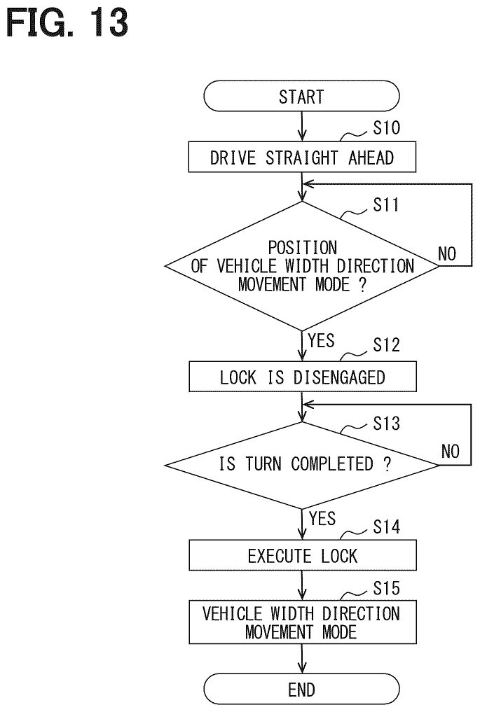

In the present embodiment, the control unit 47 and the host ECU 48 correspond to a “control device”. The functions provided by the microcomputers of the control unit 47 and the host ECU 48 may be provided by software stored in a tangible memory device and a computer executing the software, only software, only hardware, or a combination of the software and the hardware. For instance, suppose that the microcomputer be provided by including or using a hardware circuit serving as an electronic circuit. Such an electronic circuit may be provided by including analog circuitry and/or digital circuitry including multiple logic circuits. For example, the microcomputer executes a program stored in a non-transitory tangible storage medium serving as a storage unit included therein. The programs include, for example, a drive control processing program shown in FIG. 13. With the execution of the program, a method corresponding to the program is executed. The storage unit is, for example, a non-volatile memory. The programs stored in the storage unit can be updated via a network such as the Internet, for example, over the air (OTA).

Next, the steering mechanism 70 will be described with reference to FIG. 2 and FIGS. 7 to 10.

The steering mechanism 70 is a mechanism for supporting the drive unit 22 rotatably around a steering center shaft that extends in the vertical direction relative to the base portion 11.

The steering mechanism 70 includes a base portion 71 fixed to the housing of the drive unit 22. The base portion 71 includes a rectangular base plate 72 whose upper surface is parallel to the mounting surface 11a of the base portion 11, and a side plate 73 extending downward from one of the four edges of the base plate 72. The base plate 72 is fixed to the upper part of the drive unit 22, more specifically, to the upper parts of the first housing 51 and the second housing 61. The side plate 73 is fixed to a side surface of the second housing 61. As shown in FIG. 4, the side plate 73 has a through hole 73a through which the drive shaft 65 is inserted. The base plate 72 is provided with a steering center shaft 74 extending upward from the base plate 72.

The steering mechanism 70 includes a case 75 corresponding to the “fixed portion” and a steering bearing 76. The steering bearing 76 is a rolling bearing having an inner ring 76a, an outer ring 76b, and an intermediate accommodating portion 76c that accommodates a plurality of rolling elements (specifically, rollers or balls, for example) provided between the inner ring 76a and the outer ring 76b. The case 75 is formed with a through hole 75a extending in the vertical direction, and the case 75 is in a cylindrical shape. The steering bearing 76 is fitted into the through hole 75a, and an outer ring 76b is fixed to the case 75. The upper part of the case 75 is fixed to the lower part of the base portion 11. An inner wheel 76a is fixed to the upper end of the steering center shaft 74. The steering mechanism 70, the drive unit 22, and the drive wheels 21 are capable of rotating together around the steering center shaft 74 with respect to the base portion 11.

The steering mechanism 70 includes a linear actuator 80, which is an electric actuator, a lock pin 81, which corresponds to a “restricting member”, an interlocking mechanism 82, a first stopper portion 90 and a second stopper portion 91, as components for allowing and restricting rotation of the drive unit 22 and the drive wheels 21 around the steering center shaft 74 relative to the base portion 11.

The lock pin 81 has an elongated shape and extends in a direction perpendicular to the longitudinal direction of the steering center shaft 74. The lock pin 81 is arranged with a first end in the longitudinal direction facing the steering center shaft 74.

The linear actuator 80 has an elongated shape and is fixed to the upper surface of the base plate 72. The linear actuator 80 includes an elongated linear motion section 80a extending in a direction perpendicular to the steering center shaft 74, and a drive section 80b that houses the base end side of the linear motion section 80a. The drive section 80b is fixed to the base plate 72 while being disposed in a groove portion 77 formed in the base plate 72. The drive section 80b is controlled to energize by the control unit 47 or the host ECU 48 to reciprocate the linear motion section 80a in the longitudinal direction of the linear motion section 80a. The linear motion section 80a is disposed in parallel with the lock pin 81 with the longitudinal direction of the linear motion section 80a and the longitudinal direction of the lock pin 81 being in the same direction.

By arranging the linear actuator 80 and the lock pin 81 in parallel, it is possible to prevent the longitudinal dimension of the lock mechanism including the linear actuator 80 and the lock pin 81 from becoming large. This makes it possible to miniaturize the steering mechanism 70.

The interlocking mechanism 82 is a mechanism for interlocking the operation of the linear motion section with the operation of the lock pin 81, and includes a bush 83 (specifically, a linear bush), a connecting member 84, and a shaft portion 84a. The bush 83 is fixed to the base plate 72 in a state aligned with the drive section 80b, and supports the lock pin 81 so that the lock pin 81 is movable in the longitudinal direction.

The connecting member 84 has an elongated shape and extends in a direction perpendicular to the steering center shaft 74. The shaft portion 84a extends upward from the base plate 72, and is provided between the linear motion section 80a and the lock pin 81 in the direction in which the linear motion section 80a and the lock pin 81 are aligned. The shaft portion 84a is connected to a middle portion of the connecting member 84 so that the connecting member 84 can rotate around the shaft portion 84a with the middle portion of the connecting member 84 in the longitudinal direction as the center of rotation.

A first through hole is formed in a first end portion in the longitudinal direction of the connecting member 84. With a head of the first bolt facing upward, the shaft portion of the first bolt is inserted into the first through hole. The tip end of the shaft portion of the first bolt is fixed to the tip end of the linear motion section 80a. The tip end of the linear motion section 80a is connected to the first end of the connecting member 84 so that the first end of the connecting member 84 can rotate about an axis in the vertical direction relative to the tip end of the linear motion section 80a.

A second through hole is formed in a second end portion in the longitudinal direction of the connecting member 84. With a head of the second bolt facing upward, the shaft portion of the second bolt is inserted into the second through hole. The tip of the shaft portion of the second bolt is fixed to a second end of the lock pin 81 in the longitudinal direction. The second end of the lock pin 81 is connected to the second end of the connecting member 84 so that the second end of the connecting member 84 can rotate about an axis in the vertical direction relative to the second end of the lock pin 81.

Since the locking mechanism, which includes the linear actuator 80, the lock pin 81, and the interlocking mechanism 82, is located between the base portion 11 of the automated guided vehicle 10 and the drive surface GL, the height dimension of the automated guided vehicle 10 can be reduced.

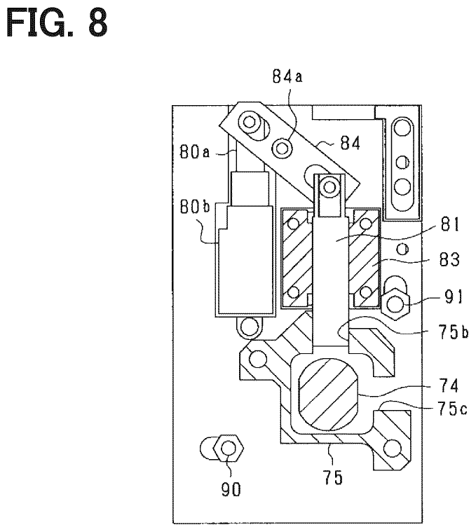

FIG. 8 is a cross-sectional view of the bush 83, the case 75, and the steering center shaft 74 of the steering mechanism 70. As shown in FIG. 8, a first rotation restricting portion 75b and a second rotation restricting portion 75c are formed on the side surface of the lower part of the case 75, and the first rotation restricting portion 75b and the second rotation restricting portion 75c restrict rotation of the case 75 around the steering center shaft 74 by fitting a first end of the lock pin 81 into them. Each of the rotation restricting portions 75b and 75c is an opening formed in a side surface of the case 75. When the steering center shaft 74 is viewed from above, the formation position of the first rotation restricting portion 75b is a position rotated 90 degrees counterclockwise from the formation position of the second rotation restricting portion 75c.

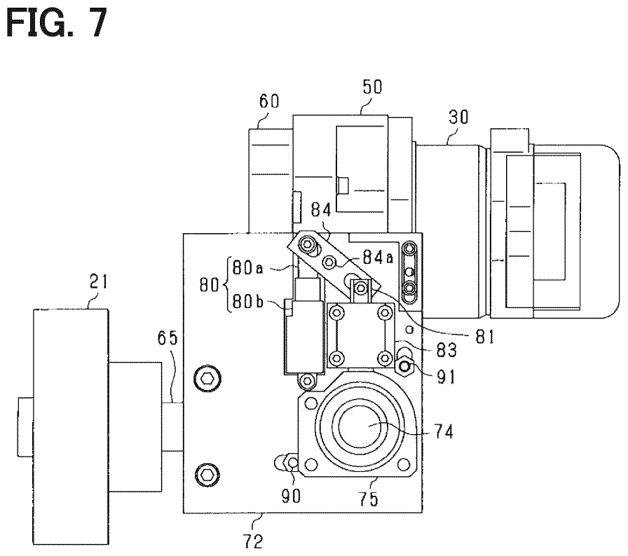

The first stopper portion 90 and the second stopper portion 91 extend upward from the base plate 72. As shown in FIGS. 7 and 8, the first stopper portion 90 is configured to abut against the side portion of the case 75 when the first end of the lock pin 81 faces the first rotation restricting portion 75b, thereby restricting the rotation of the case 75 relative to the base plate 72 around the steering center shaft 74. In other words, when the case 75 abuts against the first stopper portion 90, clockwise rotation of the case 75 relative to the base plate 72 around the steering center shaft 74 is prevented when the steering center shaft 74 is viewed from above.

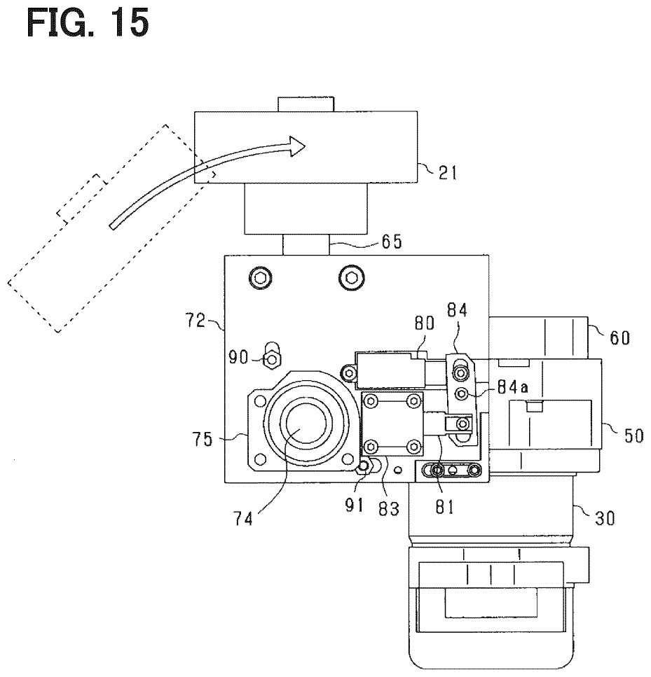

FIG. 15 is a cross-sectional view of the bush 83, the case 75, and the steering center shaft 74 of the steering mechanism 70 as in FIG. 8. As shown in FIGS. 15, the second stopper portion 91 is configured to abut against the side portion of the case 75 when the first end of the lock pin 81 faces the second rotation restricting portion 75c, thereby restricting the rotation of the case 75 relative to the base plate 72 around the steering center shaft 74. In other words, when the case 75 abuts against the second stopper portion 91, counterclockwise rotation of the case 75 relative to the base plate 72 around the steering center shaft 74 is prevented when the steering center shaft 74 is viewed from above.

The interlocking operation between the linear actuator 80 and the lock pin 81 will be described using as an example a case in which the first end of the lock pin 81 faces the first rotation restricting portion 75b. As shown in FIGS. 7 and 8, when the linear motion section 80a of the linear actuator 80 is advanced relative to the drive section 80b, the lock pin 81 operates in the direction opposite to the forward movement direction of the linear motion section 80a, and the first end of the lock pin 81 fits into the first rotation restricting portion 75b. This prevents the drive unit 22 and the drive wheels 21 from rotating around the steering center shaft 74 relative to the base portion 11. At this time, since the lock pin 81 is supported by the bush 83, the rotation of the drive unit 22 and the drive wheels 21 around the steering center shaft 74 relative to the base portion 11 can be reliably prevented.

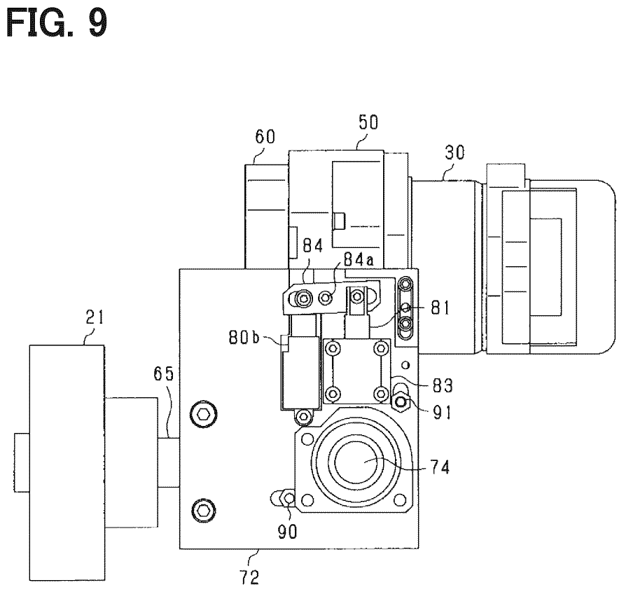

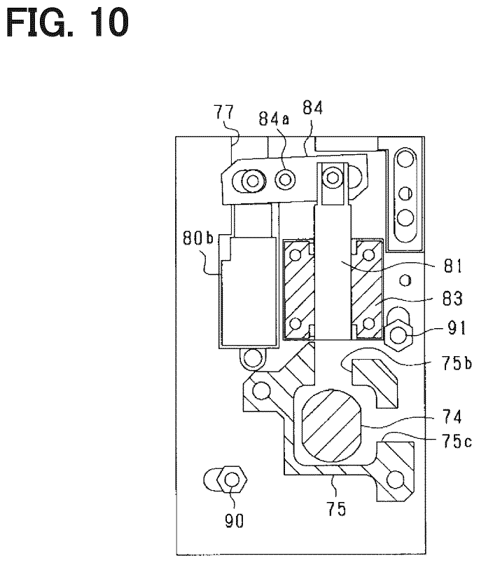

As shown in FIGS. 9 and 10, when the linear motion section 80a is retracted toward the drive section 80b, the lock pin 81 operates in the direction opposite to the retraction direction of the linear motion section 80a and the first end of the lock pin 81 disengages from the first rotation restricting portion 75b. This allows the drive unit 22 and the drive wheels 21 to rotate around the steering center shaft 74 relative to the base portion 11.

When a force in a direction intersecting the direction of motion of the linear motion section 80a acts on the linear motion section 80a, it may become difficult for the linear motion section 80a to move, or the linear motion section 80a may break down. In this regard, with the configuration including the lock pin 81, the connecting member 84, and the shaft portion 84a, a force in a direction intersecting the motion direction of the linear motion section 80a is less likely to act on the linear motion section 80a.

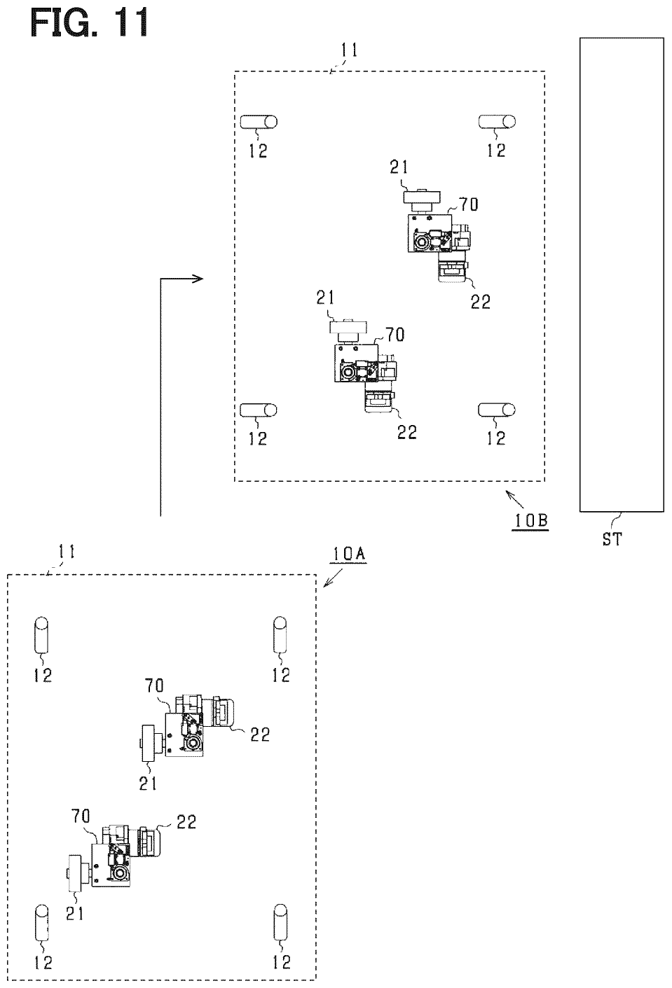

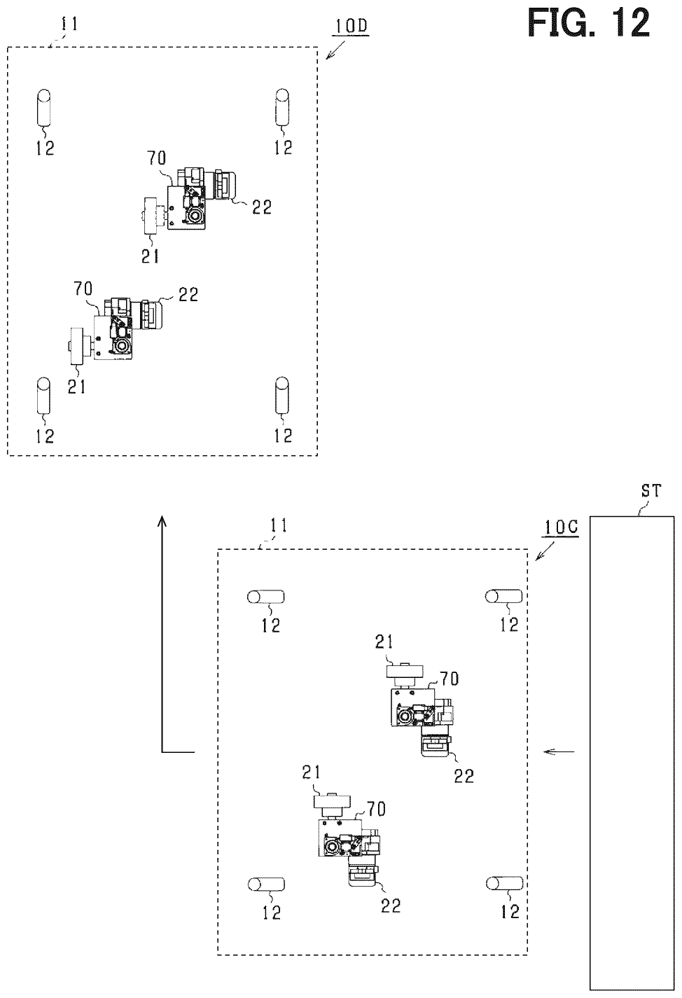

Next, an example of the drive control of the automated guided vehicle 10 will be described. In the following, as shown in FIGS. 11 and 12, a drive control will be described in which an object is placed on the mounting surface 11a of the automated guided vehicle 10, the automated guided vehicle 10 transports the object to a predetermined station ST, and then the automated guided vehicle 10 leaves the station ST.

As shown in FIG. 11, 10A denotes an automated guided vehicle that drives straight ahead. When the automated guided vehicle 10A reaches a predetermined position on the drive route in the work site, the mode is switched from the straight line drive mode to a mode in which the automated guided vehicle 10A moves in the vehicle width direction. 10B denotes an automated guided vehicle that moves in the vehicle width direction. When the automated guided vehicle 10B moves to the right and reaches the station ST, it moves the object to be transported to the station ST. Thereafter, as shown in FIG. 12, the automated guided vehicle 10C moves leftward away from the station ST. When the automated guided vehicle 10C reaches the above-mentioned predetermined position, the mode is switched from the vehicle width direction movement mode to the straight line drive mode. As a result, the automated guided vehicle 10D starts driving straight ahead.

The drive control in the case shown in FIG. 11 will be described below with reference to the flowchart of FIG. 13. This control is executed by the host ECU 48.

In step S10, in each electric drive device 20, the drive section 80b of the linear actuator 80 is controlled to energize so that the lock pin 81 is fitted into the first rotation restricting portion 75b (see FIGS. 7 and 8). As a result, the longitudinal direction of the drive shaft 65 is fixed in the same direction as the vehicle width direction. In addition, a command to rotate the rotor 31 of the motor 30 in the first direction is sent to the control unit 47 of each drive unit 22. As a result, in each drive unit 22, the control unit 47 executes switching control of the inverter 45, and the rotor 31 rotates in the first direction. As a result, the automated guided vehicle 10 drives straight ahead.

When the drive wheels 21 are not steered, the lock pin 81 restricts the rotation of the case 75 relative to the base plate 72. This allows the automated guided vehicle 10 to drive stably in a straight line.

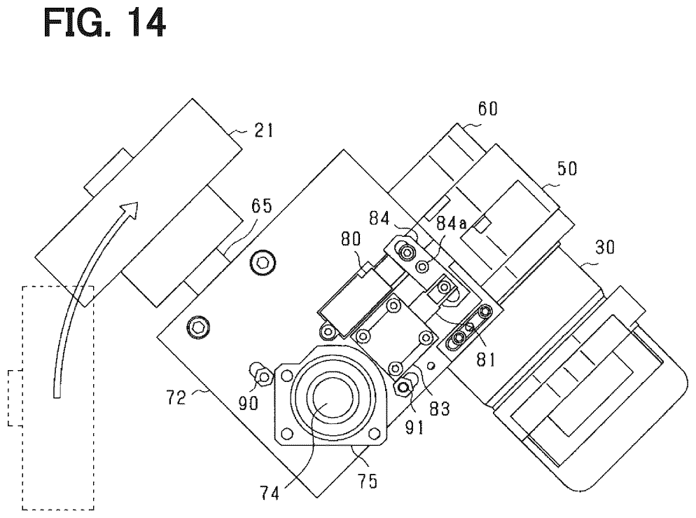

In step S11, it is determined whether the position of the automated guided vehicle 10 has reached a position where the mode is switched from the straight-line drive mode to the vehicle width direction movement mode. When the judgment in step S11 is positive, the process proceeds to step S12, and in each electric drive device 20, the power supply to the drive section 80b is controlled to energize so that the lock pin 81 is disengaged from the first rotation restricting portion 75b (corresponding to the “current rotation restricting portion”) (see FIGS. 9 and 10). In the horizontal direction, the position of the steering center shaft 74 is offset from the contact portion of the drive wheels 21 with the road surface GL on which the automated guided vehicle 10 drives. Therefore, when the rotor 31 is rotated in the first direction to rotate the drive wheels 21, a moment is generated in the steering mechanism 70 to rotate the drive unit 22 about the steering center shaft 74, as shown in FIG. 14. In this case, the drive unit 22 starts to turn around the steering center shaft 74 relative to the base portion 11 while maintaining the drive shaft 65 of the drive wheel 21 in a horizontal state. When the drive unit 22 begins to turn, the case 75 moves away from the first stopper portion 90.

In step S13, it is determined whether or not the turn of the drive unit 22 around the steering center shaft 74 has been completed. In the present embodiment, completion of turn means that the first end of the lock pin 81 faces the second rotation restricting portion 75c (corresponding to “next rotation restricting portion”) (see FIG. 15). Whether or not the turn is completed can be determined, for example, by the following methods (A) to (C).

(A) When it is determined that the case 75 abuts against the second stopper portion 91, it is determined that the turning is completed. In this case, for example, when it is determined based on the detection value of the current sensor that the maximum value of the phase current flowing through the stator winding 33a exceeds the determination current value, it can be determined that the case 75 has abutted against the second stopper portion 91.

(B) The sensor 49 includes a steering angle sensor that detects the rotation angle (steering angle) of the case 75 around the steering center shaft 74 relative to the base plate 72. It is determined that the turn has been completed based on the detection value of the steering angle sensor.

(C) The time that has elapsed since the lock pin 81 was disengaged from the first rotation restricting portion 75b is counted, and it is determined that the turn is completed when the counted elapsed time reaches a determination time.

When the case 75 abuts against the second stopper portion 91, the first end of the lock pin 81 faces the second rotation restricting portion 75c. This makes it easier to align the lock pin 81 with the second rotation restricting portion 75c, and makes it easier to fit the lock pin 81 into the second rotation restricting portion 75c.

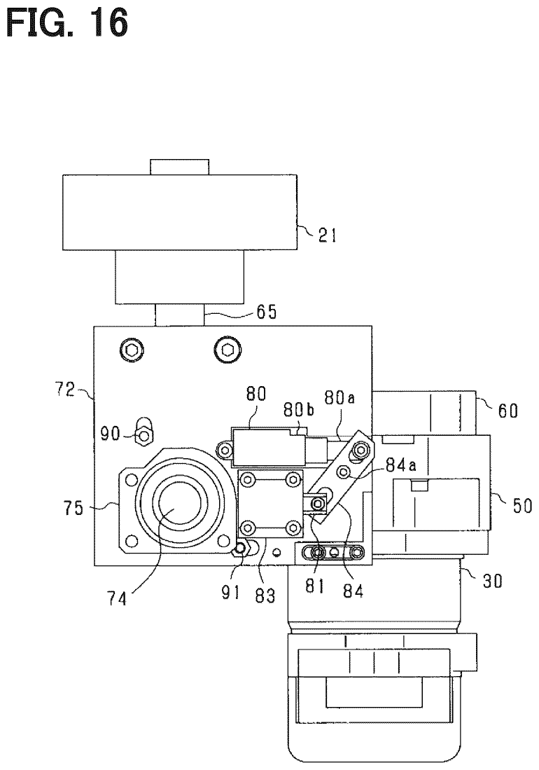

In the next step S14, the drive section 80b is controlled to energize so that the lock pin 81 is fitted into the second rotation restricting portion 75c in each electric drive device 20 (see FIG. 16). As a result, the longitudinal direction of the drive shaft 65 becomes the vehicle length direction of the automated guided vehicle 10, and the drive mode is switched to the vehicle width direction movement mode. In step S15, the rotor 31 is rotated in the first direction to rotate the drive wheels 21, thereby moving the automated guided vehicle 10 to the left toward the station ST, as shown in FIG. 11.

Although not shown in the flowchart, the drive control shown in FIG. 12 after the automated guided vehicle 10 moves the transported object to the station ST will be described.

The host ECU 48 transmits a command to the control unit 47 of each drive unit 22 to rotate the rotor 31 in a second direction that is opposite to the first direction. In each drive unit 22, the control unit 47 executes switching control of the inverter 45, and the rotor 31 rotates in the second direction. As a result, the automated guided vehicle 10 moves to the left in the vehicle width direction movement mode.

The host ECU 48 determines whether the position of the automated guided vehicle 10 has reached a position where the mode is switched from the vehicle width direction movement mode to the straight line drive mode.

When the host ECU 48 determines that the position for switching to straight-line drive mode has been reached, it energizes and controls the drive section 80b in each electric drive device 20 so that the lock pin 81 is disengaged from the second rotation restricting portion 75c (corresponding to “current rotation restricting portion”). In this state, when the rotor 31 is rotated in the second direction to rotate the drive wheels 21, the drive wheels 21 turn counterclockwise around the steering center shaft 74 when the steering center shaft 74 is viewed from above.

When the host ECU 48 determines that the case 75 abuts against the first stopper portion 90 and turn of the drive unit 22 around the steering center shaft 74 is completed, it controls to energize the drive section 80b in each electric drive device 20 so that the lock pin 81 is fitted into the first rotation restricting portion 75b (corresponding to “next rotation restricting portion”). As a result, the longitudinal direction of the drive shaft 65 becomes the vehicle width direction of the automated guided vehicle 10, and the drive mode is switched to the straight line drive mode. The host ECU 48 switches the rotation direction of the rotor 31 from the second direction to the first direction, and rotates the rotor 31 in the first direction to rotate the drive wheels 21, thereby causing the automated guided vehicle 10 to drive in a straight line, as shown in FIG. 12.

According to the present embodiment described above in detail, the drive wheels 21 can be steered by the rotational power of the motor 30 for propelling the automated guided vehicle 10. Therefore, there is no need for a motor for steering the drive wheels 21 in addition to the motor 30 for driving the automated guided vehicle 10. This simplifies the configuration of the electric drive device 20, and ultimately provides the automated guided vehicle 10 that is compact in both the vehicle width and length directions.

### Second Embodiment

Hereinafter, a second embodiment will be described with reference to the drawings, focusing on differences from the first embodiment. In the present embodiment, when the lock pin 81 is fitted into the rotation restricting portion, a rocking control is performed to rock the rotation restricting portion around the steering center shaft 74 while maintaining the opposing state of the rotation restricting portion relative to the first end of the lock pin 81.

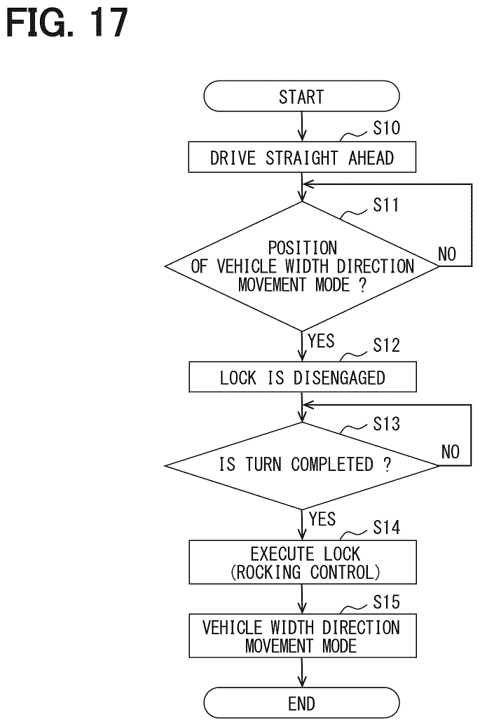

FIG. 17 is a flowchart corresponding to FIG. 13. In FIG. 17, the same process as that shown in FIG. 13 is designated by the same reference numeral for convenience.

When the determination in step S13 is positive, in step S16, the control unit 47 of each drive unit 22 is instructed to execute a rocking control, while the drive section 80b is controlled to energize so that the first end of the lock pin 81 fits into the second rotation restricting portion 75c. The rocking control is a switching control of the inverter 45 that alternately repeats rotation of the rotor 31 in the first direction and rotation in the second direction opposite to the first direction.

By using the rocking control, even if the positions of the lock pin 81 and the rotation restricting portion are slightly misaligned, the lock pin 81 can be easily fitted into the rotation restricting portion. Incidentally, the rocking control may also be performed when the lock pin 81 is disengaged from the rotation restricting portion.

### Third Embodiment

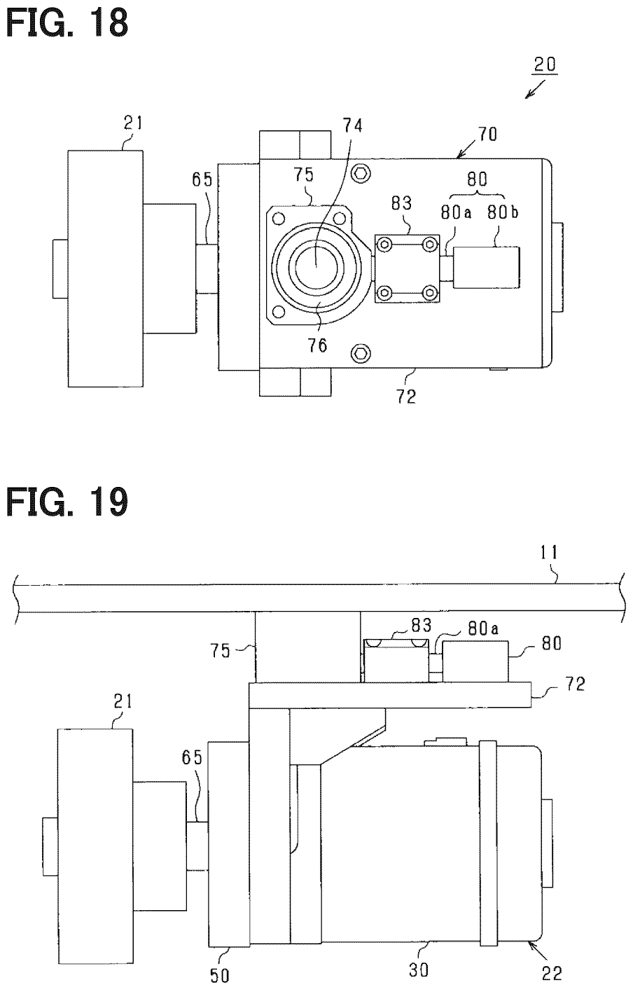

Hereinafter, a third embodiment will be described with reference to the drawings, focusing on differences from the first embodiment. In the present embodiment, as shown in FIGS. 18 and 19, the drive unit 22 does not include the second deceleration device 60. For this reason, the drive shaft 65 is connected to the planetary carrier 52C of the first deceleration device 50. As a result, the central axis of rotation of the shaft 32 of the motor 30 and the central axis of rotation of the drive shaft 65 become the same. In addition, in FIGS. 18 and 19, the same configurations as those shown in the first embodiment are denoted by the same reference numerals for convenience.

In the steering mechanism 70, the steering center shaft 74 is provided on the central axis of rotation of the drive shaft 65 when the steering center shaft 74 is viewed from above. In addition, the linear actuator 80 is also provided on the central axis of rotation of the drive shaft 65 when the steering center shaft 74 is viewed from above.

The linear motion section 80a of the linear actuator 80 is supported by a bush 83. The linear motion section 80a is disposed so that its tip portion can face the first rotation restricting portion 75b or the second rotation restricting portion 75c of the case 75. The tip of the linear motion section 80a can be fitted into the first rotation restricting portion 75b or the second rotation restricting portion 75c, and corresponds to “restricting member”. As a configuration for restricting the rotation of the case 75 relative to the base plate 72 around the steering center shaft 74, a configuration including the interlocking mechanism 82 described in the first embodiment may be used.

### Other Embodiments

The above embodiments may be changed and carried out as follows.

The case is not limited to the configurations exemplified in the above embodiments. For example, the steering bearing 76 may have an inner ring 76a fixed to the case 75 and an outer ring 76b fixed to the steering center shaft 74.

In each of the above embodiments, the steering center shaft 74, the linear actuator 80, and the interlocking mechanism 82 are provided on the base plate 72, and the upper end of the case 75 is fixed to the lower side of the base portion 11, but this configuration is not limited. For example, the steering center shaft 74, the linear actuator 80 and the interlocking mechanism 82 may be provided below the base portion 11, and the lower end of the case 75 may be fixed to the base plate 72.

The rotation restricting portion provided on the case 75 is not limited to a configuration that penetrates the side surface of the case 75, and may be, for example, a recess formed in the side surface of the case 75.

Either or both of the first stopper portion 90 and the second stopper portion 91 may be omitted.

The interlocking mechanism is not limited to the configuration shown in FIG. 3 of the first embodiment. For example, the interlocking mechanism may have a configuration in which the shaft portion 84a is not provided. In this case, the tip end of the linear motion section 80a is connected to the first end of the connecting member 84 so that the first end of the connecting member 84 cannot rotate about the vertical axis relative to the tip end of the linear motion section 80a, and the second end of the lock pin 81 is connected to the second end of the connecting member 84 so that the second end of the connecting member 84 cannot rotate about the vertical axis relative to the second end of the lock pin 81. In this configuration, when the linear motion section 80a is advanced relative to the drive section 80b, the lock pin 81 operates in the same direction as the forward movement of the linear motion section 80a, and the first end of the lock pin 81 disengages from the rotation restricting portion. On the other hand, when the linear motion section 80a is retracted toward the drive section 80b, the lock pin 81 moves in the same direction as the retraction direction of the linear motion section 80a, and a first end of the lock pin 81 fits into the rotation restricting portion.

The configuration for operating the linear motion section is not limited to a linear actuator, and may be, for example, a solenoid.

The motor is not limited to an inner rotor type, but may be an outer rotor type.

The automated guided vehicle is not limited to a six-wheel vehicle having two drive wheels and four driven wheels, but may be, for example, a four-wheel vehicle having two drive wheels and two driven wheels, or a three-wheel vehicle having two drive wheels and one driven wheel. Furthermore, the automated guided vehicle may have all of its wheels as drive wheels.

The automated guided vehicles used in factories are not limited to AGVs, and may be, for example, autonomous mobile robots (AMRs).

Furthermore, the small mobility is not limited to the automated guided vehicle, but may be, for example, a small electric vehicle such as an electric wheelchair or a senior car. A small electric vehicle is, for example, a vehicle with a driving speed of 10 km/h or less.

The control units and methods thereof described in the present disclosure may be implemented by a dedicated computer including a processor programmed to execute one or more functions embodied by a computer program and a memory. Alternatively, the control units and the methods thereof described in the present disclosure may be implemented by a dedicated computer including a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

Although the present disclosure has been described with reference to exemplary embodiments, it is understood that the present disclosure is not limited to such exemplary embodiments and structures. The present disclosure encompasses various modifications and variations within the scope of equivalents. In addition, while the various combinations and configurations, which are preferred, other combinations and configurations, including more, less or only a single element, are also within the spirit and scope of the present disclosure.

What is claimed is:

1. An electric drive device that is applied to a vehicle having drive wheels and that rotates the drive wheels about a rotation central axis extending in a horizontal direction to drive the vehicle, the electric drive device, comprising:
a drive unit provided below a base portion of the vehicle, the drive unit having a motor and a transmission mechanism connected to the drive wheels and transmitting a rotational power of the motor to the drive wheels; and
a steering mechanism having a steering center shaft extending in a vertical direction and provided below the base portion;
wherein
the steering mechanism supports the drive unit rotatably about the steering center shaft relative to the base portion while maintaining a rotation central axis of the drive wheels in a horizontal state, and
the steering mechanism is configured such that a position of the steering center shaft is offset in the horizontal direction from a contact area of the drive wheels with a driving road surface.

2. The electric drive device according to claim 1, wherein
the steering mechanism includes
a restricting member movable between a position that allows rotation of the drive unit about the steering center shaft and a position that restricts the rotation of the drive unit about the steering center shaft, and
an actuator for operating the restricting member.

3. The electric drive device according to claim 2, wherein
the steering mechanism includes
a fixing portion fixed to an underside of the base portion,
a base portion disposed below the fixed portion and to which the actuator is fixed, and
a bearing including an inner ring, an outer ring, and a rolling element provided between the inner ring and the outer ring,
the steering center shaft is fixed to the base portion so as to extend upward from the base portion,
one of the inner ring and the outer ring is fixed to the steering center shaft, and the other is fixed to the fixed portion,
the base portion is rotatable around the steering center shaft relative to the fixed portion,
the actuator includes
a long linear motion section extending in a direction perpendicular to the steering center shaft, and
a drive section provided on a base end side of the linear motion section and fixed to the base portion, and configured to reciprocate the linear motion section in a longitudinal direction of the linear motion section,
the restricting member has an elongated shape,
the restricting member is arranged in parallel with the linear motion section with a first end facing the steering center shaft and a longitudinal direction of the restricting member and a longitudinal direction of the linear motion section being the same direction,
a rotation restricting portion into which a first end of the restricting member is fitted to restrict rotation of the fixed portion around the steering center shaft is provided on a side surface of the fixed portion, and
an interlocking mechanism is provided on the base portion and links an operation of the linear motion section with an operation of the restricting member.

4. The electric drive device according to claim 3, wherein
the interlocking mechanism includes:
a shaft portion provided between the linear motion section and the restricting member in a direction in which the linear motion section and the restricting member are arranged and extending upward from the base portion, and
a connecting member having an elongated shape,
the shaft portion is connected to an intermediate portion so that the connecting member can rotate around the shaft portion with the intermediate portion in the longitudinal direction of the connecting member as a rotation center,
a tip end of the linear motion section is connected to a first end of the connecting member such that the first end of the connecting member can rotate about an axis in a vertical direction relative to the tip end of the linear motion section,
a second end of the restricting member is connected to a second end of the connecting member such that the second end of the connecting member can rotate about an axis in a vertical direction relative to the second end of the restricting member,
when the linear motion section is advanced relative to the drive unit, the restricting member is operated in a direction opposite to an advancing direction of the linear motion section, and a first end of the restricting member is fitted into the rotation restricting portion, and
when the linear motion section is retracted toward the drive unit, the restricting member moves in a direction opposite to a retracting direction of the linear motion section, and the first end of the restricting member is disengaged from the rotation restricting portion.

5. The electric drive device according to claim 3, wherein
the rotation restricting portion is provided at each of different positions on a side surface portion of the fixing portion in a circumferential direction around the steering center shaft,
a stopper portion is provided on the base portion, and
the stopper portion is configured to abut against the fixed portion when a first end of the restricting member faces any one of the rotation restricting portions, thereby restricting the rotation of the fixed portion around the steering center shaft.

6. The electric drive device according to claim 5, further comprising,
a control unit configured to control energization of the motor and energization of the drive unit for operating the linear motion section, wherein
the control unit
controls the energization of the motor to rotate a rotor constituting the motor in a first direction to turn the drive wheels around the steering center shaft, after controlling the drive of the drive unit to disengage the first end of the restricting member from a current rotation restricting portion in which the first end of the restricting member is currently fitted,
determines whether or not, after the drive wheel starts to turn, the first end of the restricting member faces a next rotation restricting portion, which is a next fitting destination of the first end of the restricting member, among the rotation restricting portions, and
when it is determined that the first end of the restricting member is facing the next rotation restricting portion, controls a current supply to the motor and the drive unit so as to maintain the first end of the restricting member facing the next rotation restricting portion and to engage the first end of the restricting member with the next rotation restricting portion while alternately repeating rotation of the rotor in the first direction and rotation in a second direction opposite to the first direction.

7. The electric drive device according to claim 6, wherein
the vehicle to which the electric drive device is applied is an automated guided vehicle used in a work site.

8. The electric drive device according to claim 4, wherein
the rotation restricting portion is provided at each of different positions on a side surface portion of the fixing portion in a circumferential direction around the steering center shaft,
a stopper portion is provided on the base portion, and
the stopper portion is configured to abut against the fixed portion when a first end of the restricting member faces any one of the rotation restricting portions, thereby restricting the rotation of the fixed portion around the steering center shaft.
